(19) United States
(12) Patent Application Publication
(10) Pub. No.: US 2015/0171724 A1
(43) Pub. Date: Jun. 18, 2015

(54) DEVICE WITH MAGNETIC COUPLER AND ELECTRIC TOOL ASSEMBLY HAVING SUCH A DEVICE

(71) Applicant: Hayco Manufacturing Ltd., Causeway Bay (HK)

(72) Inventors: Gregory Clegg SPOONER, Mid-levels (HK); Hoss VONG, Ma On Shan Center (HK)

(73) Assignee: Hayco Manufacturing Ltd., Causeway Bay (HK)

(21) Appl. No.: 14/494,358

(22) Filed: Sep. 23, 2014

(30) Foreign Application Priority Data
Dec. 16, 2013 (HK) 13113926.7

(51) Int. Cl. H02K 49/10; A61C 17/34; H02K 15/00

(52) U.S. Cl. CPC H02K 49/104; H02K 15/00; A61C 17/3472

(57) ABSTRACT

The present invention is concerned with a device for converting a rotating input motion into a modified output motion. The device has a magnetic coupler including a secondary magnet, a motion output member, and one, or at least a first, primary magnet. The magnetic or polarity profile of the first primary magnet and the magnetic or polarity profile of the secondary magnet are different. The device is configured such that rotating movement of the first primary magnet translates to a combination of rotating and oscillating movement of the motion output member.

### FIELD OF THE INVENTION

The present invention is concerned with a device for converting a rotating motion into a combination of a rotating motion and oscillating motion, for use, for example in an electric appliance, electric tool, cleaning apparatus such as an electric brush, electric floor mop.

### BACKGROUND OF THE INVENTION

There are conventional devices which are designed to transfer motion from one location to another. Depending on the resulting motion desired, such devices are typically complex, and involve the use of complex mechanical components such as gears or cam structures. The complexity often means that many parts are required in a finite or limited amount of space, thus translating to difficulties and high cost in manufacturing. Further, such complex devices would tend to develop problems or break down easily.

The present invention is concerned with a device for converting a rotating motion into a combination of a rotating motion and oscillating motion, and at the same time address issues of complexity, cost, manufacturing efficiency and durability.

### SUMMARY OF THE INVENTION

According to a first aspect of the present invention, there is provided a device for converting a rotating input motion into a modified output motion comprising a) an electric motor with a rotatable shaft defining a rotation axis, b) at least one primary magnet connected to the rotatable shaft and configured to spin with the rotatable shaft in use at the rotation axis, c) a secondary magnet arranged between the primary magnet and a modified motion output means for generating, in response to movement or change in magnetic field of the primary magnet, a modified output motion to the modified motion output means, wherein the primary magnet includes two ends defining north pole and south pole thereof, and the secondary magnet includes two ends defining north pole and south pole thereof, and the primary and secondary magnets have different magnetic profiles, whereby rotational movement of the primary magnet causes change in magnetic field, resulting in the modified output motion of the modified output means, wherein the modified output motion is a combination of rotating motion and oscillating motion, and wherein the magnetic profile of the primary magnet resembles two halves defining the north pole and the sole pole of the primary magnet.

Preferably, the device may comprise at least two permanent magnets, the at least two permanent magnets may include the primary magnet and the secondary magnet.

In an embodiment, the device may comprise one primary magnet in the form of a disc, said circular disc including the two halves in two semi-circular portions defining the north pole and the south pole of the primary magnet. The secondary magnet may be in the form of a disc with the first end resembling a first circular layer defining the north pole and the second end forming a second circular layer defining the south pole, and with either the north pole or the south pole of the secondary magnet facing the primary magnet.

In another embodiment, the device may comprise two primary magnets each in the form of a semi-circular disc and arranged adjacent each other and together forming a larger circular magnetic disc. The secondary magnet may be in the form of a disc with the first end resembling a first layer defining the north pole and the second end forming a second layer defining the south pole, and with either the north pole or the south pole of the secondary magnet facing the two primary magnets.

Suitably, the device may comprise a holder for securing the primary magnet to the rotatable shaft.

In one embodiment, the device may comprise dampening means arranged between the primary magnet and the secondary magnet for absorbing noise or shock when the motor is in operation. The dampening means may in the form of a sponge pad or Teflon pad.

In a further embodiment, the modified motion output means may include or take the form of a holder from which a modified motion output shaft extends or to which the modified motion output shaft connects, and configured to abut or engage the secondary magnet whereby motion from the secondary magnet is translated to the modified motion output shaft. The device may comprise means for securing the secondary magnet in the device, wherein a clearance is provided between the secondary magnet and surrounding structure of the secondary magnet whereby in operation the secondary magnet is movable within the clearance and the modified motion output shaft is caused to deliver the modified output motion. Suitably, an O-ring acting as a cushion may be provided in the clearance surrounding the secondary magnet.

The device may comprise a housing having a first housing member primarily for accommodating the motor and a second housing member for securing the secondary magnet in place and for connection with the first housing member, wherein the modified motion output shaft may be provided to extend via an opening of the second housing member.

According to a second aspect of the present invention, there is provided a method of constructing a device for generating a combination of rotational motion and oscillation motion in a motion output means, comprising a) providing a first motion means in the form of a rotatable motion output shaft driven by a motor, the first motion means adapted to a rotate at a rotation axis, b) providing a primary magnet connected to the first motion means and adapted to rotate with the first motion output means, the primary magnet configured with two ends resembling two semi-circular discs, one in north pole and the other in south pole, c) providing a secondary magnet positioned adjacent the primary magnet, the secondary magnet configured with two layers resembling two circular discs, one in north pole and the other in south pole, d) positioning the secondary magnet such that either the north pole or the south pole of the secondary magnet faces the primary magnet, e) providing a second motion means in the form of an output seat member and abutting the secondary magnet such that movement of the secondary magnet is translated to the second motion means, and f) securing the second motion means in the device and allowing a clearance surrounding the second motion device such that, in operation, rotation of the first output means translates to a combination of rotational motion and oscillation motion in the third motion output device in the form of an output shaft extended from the second motion means.

According to a third aspect of the present invention, there is provided a device for converting a rotating input motion into a modified output motion comprising a magnetic coupler including a secondary magnet, a motion output member, and at least one first primary magnet, wherein magnetic or polarity profile of the first primary magnet and the magnetic or polarity profile of the secondary magnet are different, and wherein the device is configured such that rotating movement of the primary magnet translates to a combination of rotating and oscillating movement of the motion output member.

According to a fourth aspect of the present invention, there is provided an electric tool assembly comprising a device as described above. The tool assembly may be an electric brush or an electric toothbrush.

### BRIEF DESCRIPTION OF DRAWINGS

Some embodiments of the present invention will now be explained, with reference to the accompanied drawings, in which:—

FIG. 1 is a perspective view of an embodiment of a device for converting a rotating input motion to a modified output motion according to the present invention;

FIG. 3 is a side view of the device of FIG. 1;

FIG. 5 is other side view of the device of FIG. 1;

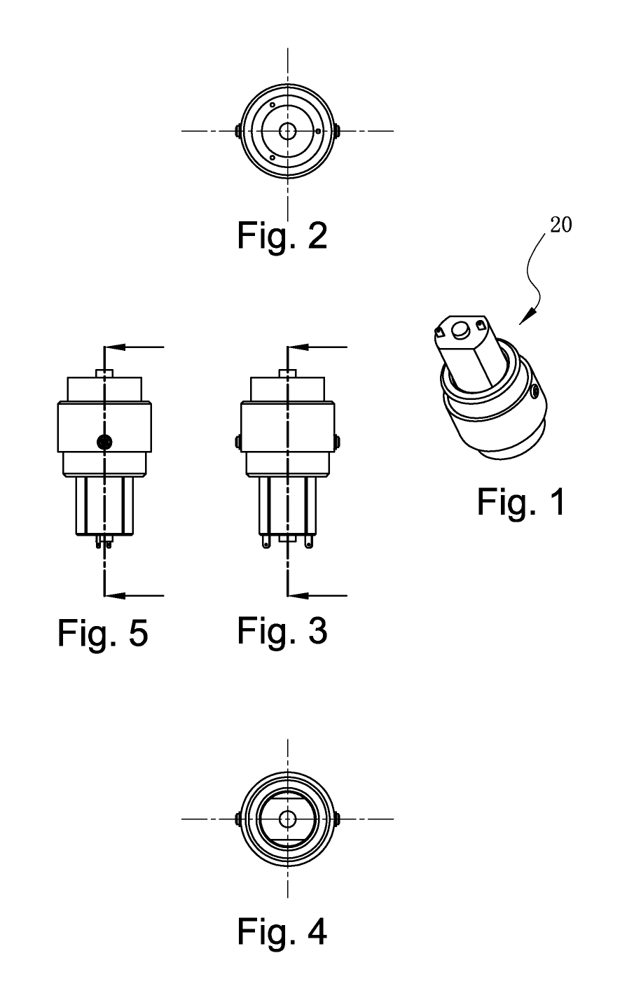

FIG. 2 and FIG. 4 are opposite end (top and bottom) views of the device of FIG. 1;

FIG. 6 is a schematic diagram showing an exploded view of the device of FIG. 1;

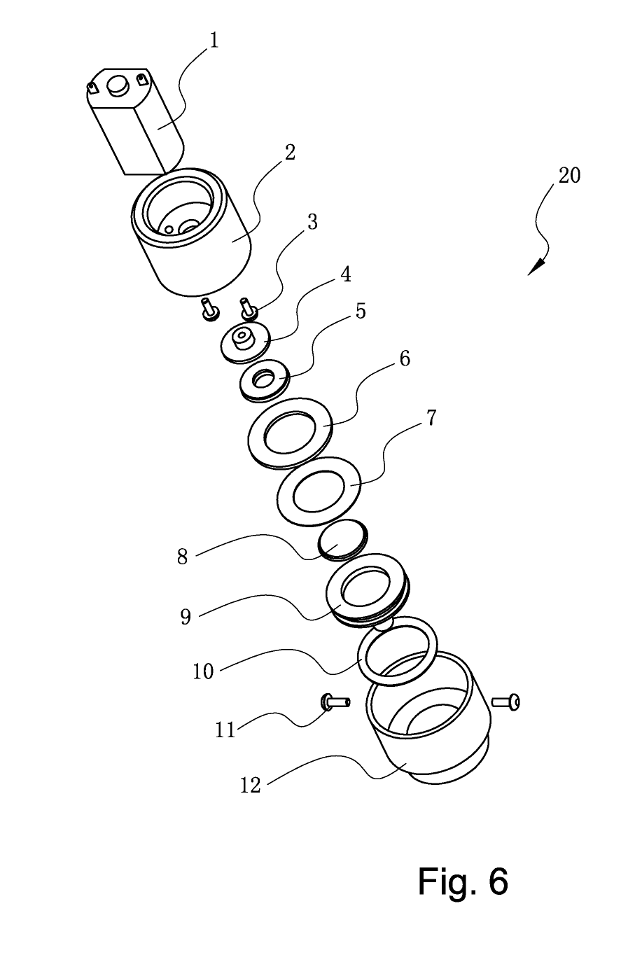

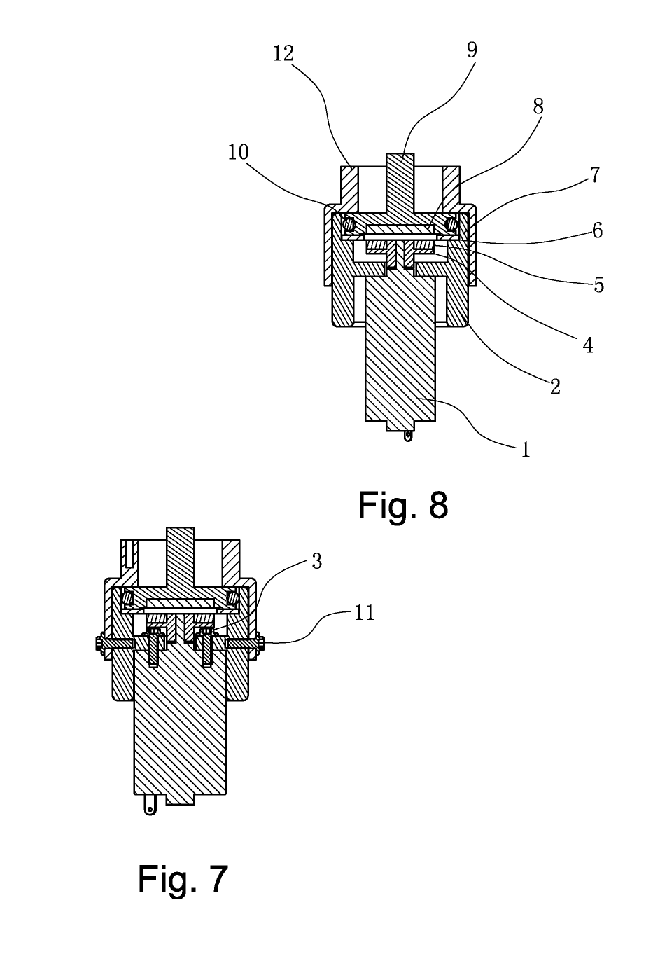

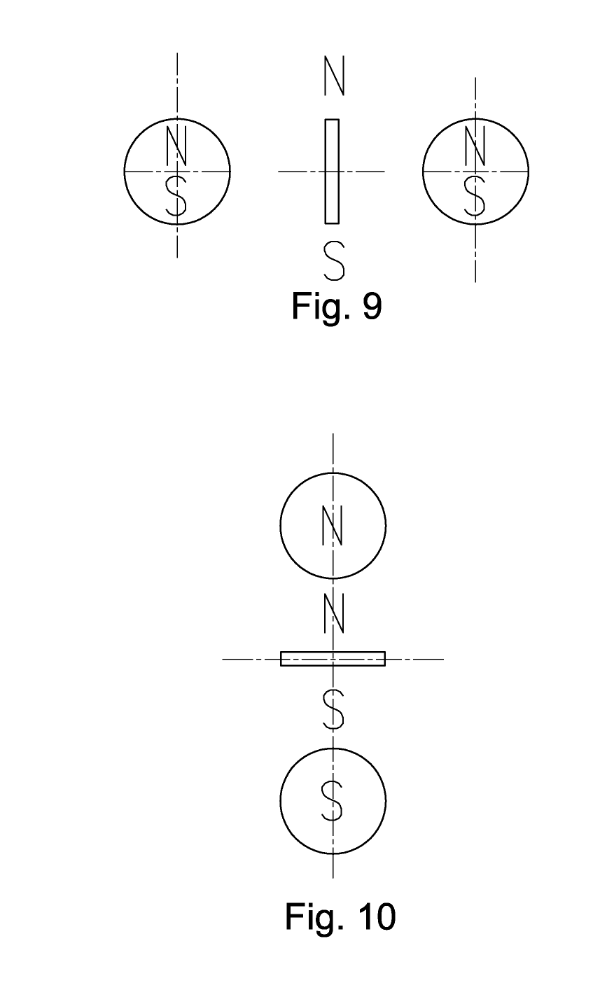

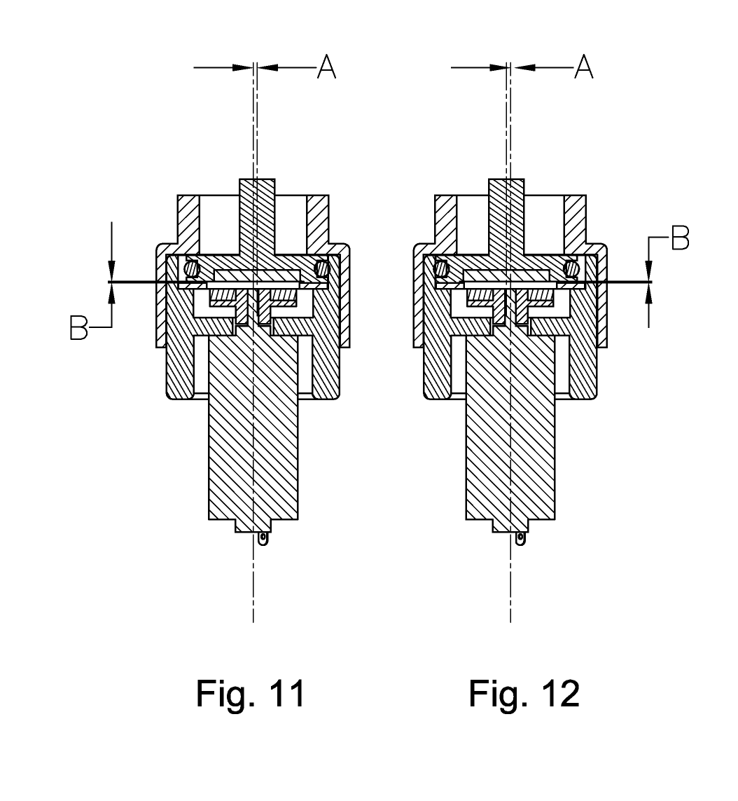

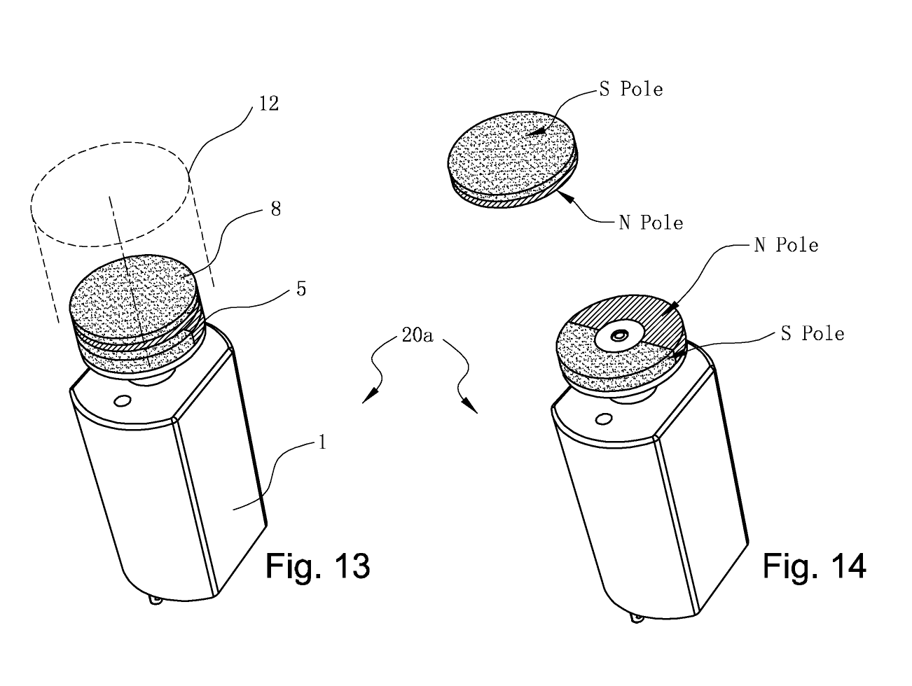

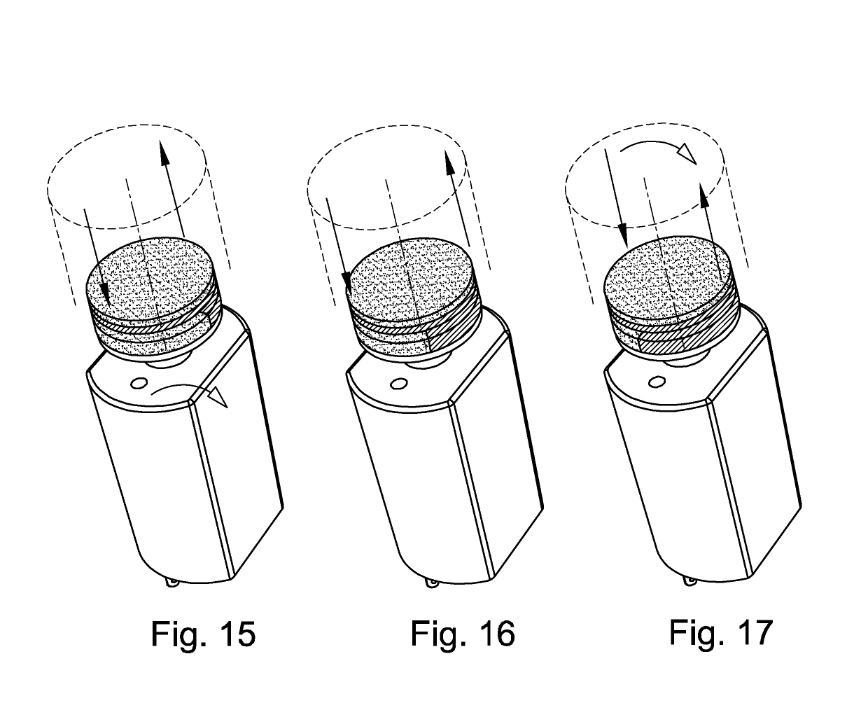

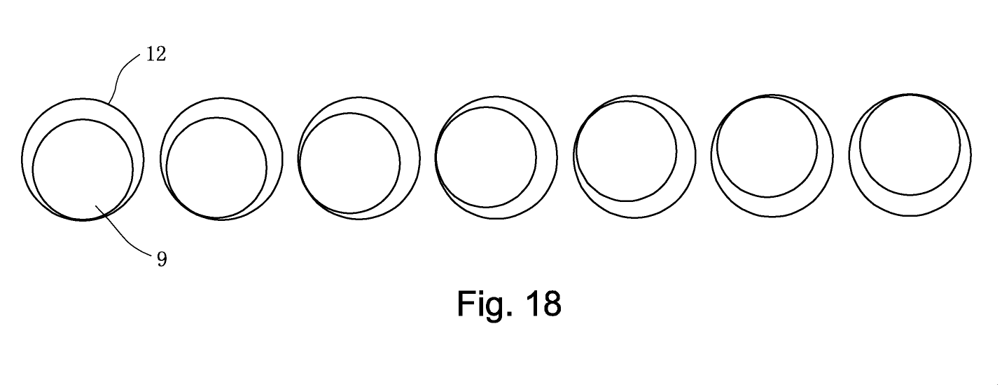

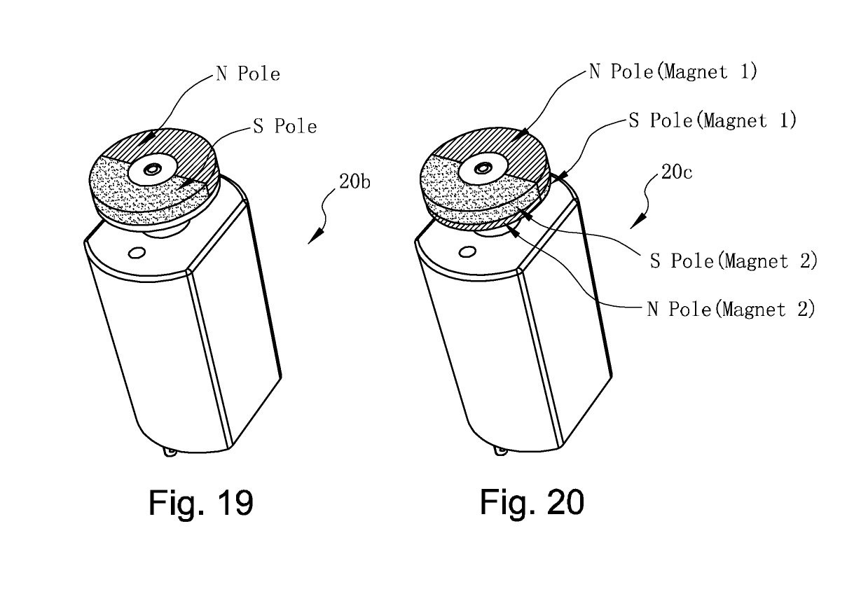

FIG. 7 is a cross sectional view of the device of FIG. 5;

FIG. 8 is a second cross section view of the device of FIG. 3;

FIG. 9 is a schematic diagram showing polarity configuration of a primary magnet used in the device of FIG. 1;

FIG. 10 is a schematic diagram showing polarity configuration of a secondary magnet used in the device of FIG. 1;

FIGS. 11 and 12 are enlarged cross sectional views showing two configurations of the device of FIG. 1 in operation;

FIG. 13 shows, 3-dimensionally, another embodiment of a device similar to the device in FIGS. 1-12;

FIG. 14 shows the device of FIG. 13, with a secondary magnet situated above a primary magnet for illustration purpose;

FIGS. 15 to 17 are three successive schematic diagrams, showing operation of the device of FIG. 13 and movement of the primary magnet and the secondary magnet;

FIG. 18 is a schematic diagram showing movement of the secondary magnet in the device of FIG. 13;

FIG. 19 is another embodiment of a device similar to the devices in FIGS. 1 and 13; and

FIG. 20 is yet another embodiment of a device with different magnetic configuration from that of FIG. 19.

### DETAILED DESCRIPTION OF PREFERRED EMBODIMENTS OF THE INVENTION

Conventional motors have been widely used to output a rotating motion. Many appliances have made use of conventional motors to generate such rotating motion. For example, a typical electric hair dryer makes use of an electric motor to generate a simple rotating motion of its fan blades. The present invention is however concerned with an electro-mechanical device for converting a rotating motion into a combination of rotating motion and oscillating motion.

FIGS. 1 to 5 show a first embodiment of a device for converting a rotating motion into a combination of rotating motion and oscillating motion according to the present invention. The device is generally designated 20 and includes a motor housing 2 for accommodating a motor 1.

FIG. 6 is an exploded view of the device 20. The device 20 has the motor 1 received in the motor housing 2 when assembled. In the embodiment, the motor 1 is secured to the motor housing 2 with two screws 3 although in other embodiments other means of securing the motor 1 may be used. For example, the motor 1 may be secured by snap-fitting to the housing 2.

A motor shaft is provided in the device 20 and extends from the motor 1. The device 20 includes a primary magnet 5 and a magnet holder 4 which connects the motor shaft and the primary magnet 5. Although this embodiment makes use of the magnet holder 4 to connect the motor shaft and the primary magnet 5, as long as the primary magnet 5 is connected with and can spin or otherwise rotate with the motor shaft this magnet holder 4 is not essential. The device 20 is provided with means to absorb noise or shock generated during operation. In this embodiment, such noise or shock absorption means 6 takes the form of a Teflon pad. A further vibration absorption means 6 in the form of a soft pad is also provided. However, in alternative embodiments if vibration or wobbling is not a concerned no such noise or shock absorption means may be used.

The device 20 is provided with a secondary magnet 8 situated adjacent the primary magnet 5 such that the secondary magnet 8 is movable in response to movement or change of magnetic field of the primary magnet 5. The device 20 has a holder 9 for housing the secondary magnet 8. The motor housing 2 and the holder 9 together form a greater housing, with the motor housing 2 as a first part primarily for housing the motor, while the holder 9 as a second part for housing the secondary magnet 9 and for securing the secondary magnet 9 in place in the device 20. While in this embodiment, circumferential flange of the motor housing 2 is received within the holder 9, this needs not be so. As long as the motor housing 2 and the holder 9 are secured together, for example by screws 11 as in this embodiment, such configuration is acceptable. In this regard, please see FIGS. 7, 8 and 11-12.

In this embodiment, the secondary magnet holder 9 serves two roles. First, it secures the secondary magnet 8 in place. Second, the secondary magnet 9 is provided with an output shaft or other motion output means. The output shaft extends from a seat member of the secondary magnet holder 9. The output shaft may then be connected to a tool assembly (e.g. a handheld tool, a brush or a toothbrush) for driving its operation. For example, the output shaft may be connected to a brush head of an electric toothbrush or mop head of an electric floor mob for generating reciprocating movement of thereof. The device 20 is configured to provide a circumferential clearance surrounding the seat member such that in use the seat member of the secondary magnet holder 9 is movable within boundary in the clearance. In this embodiment, the boundary is defined by circumferential inner wall of the motor housing 2. The device 20 has an O-ring 10 which is disposed around the seat member of the secondary magnetic holder 9. This O-ring 10 acts as a cushion or otherwise smoothens or modulates the movement of the secondary magnet holder 9. As can be seen from FIGS. 7 and 8, the secondary magnet 8, the secondary magnet holder 9 and the O-ring 19 together sit on or above the primary magnet 5 (when the device 20 is viewed with the motor 1 arranged at a lower position and the rest of the device 20 arranged at an upper position).

As can be seen in FIGS. 6-8 and 9, the primary magnet 5 is generally in the form of a circular disc with an opening in the center for connection to the motor shaft of the motor 1. FIG. 9 schematically illustrates the magnetic profile or otherwise polarity arrangement of the primary magnet 5. In order to better understand and visualize the configuration of the primary magnet 5, the circular primary magnet 6 can be understood as consisting of two semi-circular ends or halves, with one of the ends or halves defining or in north pole and the other end or half in south pole.

Referring to FIGS. 6-8 and 10, the secondary magnet 8 is generally in the form of a circular disc but with magnetic profile different from the primary magnet 5. FIG. 10 schematically illustrates the magnet profile of the secondary magnet 8. The magnetic profile of the secondary magnet is that an upper circular end or layer of the disc defines or is in north pole while a lower circular end layer of the disc defines or is in south pole.

The device 20 configured as described above is able to convert an input rotating motion to a combinational of output rotating and oscillating motion. The primary magnet 5 and the secondary magnet 8 together act as a magnetic coupler for effecting such conversion. The following further illustrates how conversion of one type of motion to another type of motion takes place.

When the device 20 is turned on with electric power supplying to the motor 1, the motor shaft extended from the motor 1 is driven to produce a rotating motion. The primary magnet 5 connected to the motor shaft thus follows to rotate. As illustrated in FIG. 9, since the primary magnet 5 has both north pole and south pole on each face (upper layer or lower layer), magnetic field from the primary magnet 5 continues to change as it rotates. As described above, the secondary magnet 8 stays close to and adjacent the primary magnet 8 but the secondary magnet 8 is allowed to move within confinement of the secondary magnet housing 12 in the clearance. As illustrated above and in FIG. 10, the secondary magnet 8 has north pole on one face (upper circular layer) and south pole on the opposite face (lower circular layer). During operation, when the primary magnet 5 continues to rotate, this brings constant change in magnetic field from the primary magnet 5. This change in magnetic field brings magnetic influence to the secondary magnet 8, and thus movement to the secondary magnet 8. This is because as the primary magnet 5 rotates, the rotating primary magnet 5 and thus its rotating north and south poles alternately attract and repel the secondary magnet 8. The constant change in polarity of the rotating primary magnet 5 causes the secondary magnet 8 assuming a combination of rotating motion and oscillating motion resembling a hula movement. By oscillating, it means the secondary magnet swing or tilt sideways and reciprocatingly.

When the secondary magnet 8 tilts, the O-Ring 10 surrounding the secondary magnet holder 9 touches against or otherwise abuts inner surface of the motor housing 2 (or otherwise inner surface of the secondary magnetic housing 12). Contact of the O-ring 10 with the surface causes friction to arise. It is to be understood that the O-ring 10 thus acts a tire, and the secondary magnet holder 9 acts similar to a wheel of the tire and orbit or rotate in operation. Motion of the secondary magnet 8 is transferred to the secondary magnet 9 holder which effectively becomes an output shaft. While in this embodiment, the device 20 makes use of an O-ring 10, in alternative embodiments other similar cushioning means with workable frictional values can also be used.

As can be understood, the device 20 transfers an input motion from the motor 1 and the input motion is translated to a modified output motion from the secondary magnet holder 9. Means including the primary magnet 5 and the secondary magnet 8, or the magnetic coupler, translates the input motion to the modified output motion. FIGS. 11-12 illustrate movement of the secondary magnet 8 and the secondary magnet holder 9. It can be seen that in operation, the secondary magnet 8 and the secondary magnet holder 9 wobble laterally in the surrounding clearance. FIG. 11 shows the secondary magnet holder 9 leans towards a position on the far right, while FIG. 12 shows the secondary magnet holder 9 leans towards a position on the far left. The reciprocating movement between the far right and far left positions results in oscillating motion of the secondary magnet holder 9.

Although the output motion is a combination of rotating and oscillating motion, the magnetic configuration of the output motion, the rotating motion component or the oscillating motion component can be controlled. For instance, the rotating motion component can be controlled by setting an appropriate rotation speed delivered by the motor 1; and the oscillating motion component can be controlled by configuring appropriate relative strength of magnetic flux of the magnets 5, 9, relative magnetic profile of the magnets 5, 9 and the distance between the magnets 5, 9. Further, the frequency of the oscillation can be controlled via the RPM of the motor 1. The speed of the rotation of the secondary magnet holder 9 can also be adjusted by increasing or decreasing the size or distance in the clearance (or the gap) between the outside diameter of the assembled O-Ring 10 and the inside diameter of the secondary magnet housing 12. It is to be understood that, generally, the larger the clearance, the faster the secondary magnet holder 9 can spin. Further, the higher the RPM of the motor, the higher the rotation speed of output motion from the secondary magnet holder 9 or the output shaft extended therefrom.

FIGS. 1-12 illustrate the configuration of the device 20 with the magnets in particular magnetic profiles. However, it is to be noted that in other embodiments the magnetic profiles of the primary and secondary magnets may be different, as long as the primary and secondary magnets have different magnetic profiles but yet are able to convert a rotating motion as an input motion to a combination of rotating motion and oscillating motion as an output motion.

FIGS. 13-18 illustrate a second embodiment of a device 20a in accordance with the present invention. FIG. 13 shows the device 20a similar to the device 20 of FIGS. 1-12. For sake of explanation, motor housing and secondary magnet housing are removed and the device 20a is represented 3-dimensionally. For ease of comparison, like components of the device 20a of FIG. 13 are labelled or used with same numerals in FIGS. 1-12. The device 20a in FIG. 13 likewise has a motor 1 with a primary magnet 5. A secondary magnet 8 is provided over the primary magnet 5 (when the device 20a is positioned with the motor 1 in a lower position), but the position of the secondary magnet 8 is limited inside the box labeled 12 shown in dotted lines. In any event, the secondary magnet 8 sits on or otherwise stays in close proximity with the primary magnet 5.

FIG. 14 shows the polarity of both the primary magnet 5 and the secondary magnet 9. FIGS. 15-16 illustrates the influence of the primary magnet 5 to the secondary magnet 9 from the direction parallel to the motor shaft axis (as shown by the arrows). Three factors or effects occur which contribute the combination of rotating and oscillating motion. First, there is a tipping over effect produced by the device 20a. It is envisaged that when the motor 1 is powered, the primary magnet 5 follows to spin. The north pole of the primary magnet 5 attracts the south pole of the secondary magnet 8, while the south pole of the primary magnet 5 repels the south pole of the secondary magnet 8 on the other side. This results in a tip-over force to the secondary magnet 8.

While this tip-over force is taking place, a second factor is kicking in at the same time to effect the secondary magnet 8 to spin or rotate. Similarly, when the motor 1 is powered, the primary magnet 5 follows to spin. The north pole of the primary magnet 5 attracts the south pole of the secondary magnet 8, while the south pole of the primary magnet 5 repels the south pole of the secondary magnet 8 on the other side. This results in a tip-over force to the secondary magnet 8. This tip-over force which is the result of two force components further forms a spinning motion as time passes. The secondary magnet 8 therefore assumes a combination of rotating and oscillating motion or resembles a hula movement.

A third factor is also present to control the movement of the secondary magnet 8 or its output motion. FIG. 18 shows the secondary magnet holder 9 confined in the secondary magnet holder housing 12. Without this housing 12, the secondary magnet 8 would either stick with the primary magnet 5 or be driven out from the device. The repelling force acts on the secondary magnet 8 and causes it to tilt or push its holder 9 off center, and to lean on the inside of the housing 12. The difference in diameter between the internal surface of the housing 12 and the external surface of the secondary magnet holder 9 forms in a reduction of rotation. They work together in a similar fashion as a cycloidal drive.

Although devices in FIGS. 1-10 and FIGS. 11-18 adopt a magnetic coupler with specific magnetic configurations, in different embodiments other magnetic configurations may be used. For example, the orientation of the secondary magnet can be random or at least different. In one embodiment, the north pole and the south pole can be switched without affecting the attraction and repelling behavior in the device. Nevertheless, the results of the tip-over force as explained above would be identical.

FIG. 19 illustrates a third embodiment of a device 20b in accordance with the present invention. FIG. 19 shows the current design with only one primary magnet. FIG. 20 illustrates a fourth embodiment of a device 20c in accordance with the present invention. The device 20c of FIG. 20 is different in that two primary magnets each in semi-circular profile are disposed next to each other. The two primary magnets together form a large circular magnetic disc. Other magnetic configurations are workable and each would have different characteristics. However, the fundamental principle remains the same, i.e. to make use of a magnetic coupler to generate modified output motion(s), the magnetic coupler making use of primary magnet(s) and secondary magnet(s) which have different magnetic configurations.

It should be understood that certain features of the invention, which are, for clarity, described in the content of separate embodiments, may be provided in combination in a single embodiment. Conversely, various features of the invention which are, for brevity, described in the content of a single embodiment, may be provided separately or in any appropriate sub-combinations. It is to be noted that certain features of the embodiments are illustrated by way of non-limiting examples. Also, a skilled person in the art will be aware of the prior art which is not explained in the above for brevity purpose.

1. A device for converting a rotating input motion into a modified output motion comprising:
an electric motor with a rotatable shaft defining a rotation axis;
at least one primary magnet connected to the rotatable shaft and configured to spin with the rotatable shaft in use at the rotation axis;
a secondary magnet arranged between the at least one primary magnet and a modified motion output means for generating, in response to movement or change in magnetic field of the at least one primary magnet, a modified output motion to the modified motion output means;
wherein the at least one primary magnet includes two ends defining north pole and south pole thereof, and the secondary magnet includes two ends defining north pole and south pole thereof, and the primary and secondary magnets have different magnetic profiles, whereby rotational movement of the at least one primary magnet causes change in magnetic field, resulting in the modified output motion of the modified motion output means;
wherein the modified output motion is a combination of rotating motion and oscillating motion; and
wherein the magnetic profile of the at least one primary magnet resembles two halves defining the north pole and the south pole of the at least one primary magnet.

2. The device as claimed in claim 1, comprising at least two permanent magnets, the at least two permanent magnets include the at least one primary magnet and the secondary magnet.

3. The device as claimed in claim 1, comprising one said primary magnet in the form of a circular disc, and said circular disc including the two halves in two semi-circular portions defining the north pole and the south pole of the one primary magnet.

4. The device as claimed in claim 3, wherein the secondary magnet is in the form of a disc with the a first end resembling a first circular layer defining the north pole and the a second end forming a second circular layer defining the south pole, and with either the north pole or the south pole of the secondary magnet facing the one primary magnet.

5. The device as claimed in claim 1, comprising two said primary magnets each in the form of a semi-circular disc and arranged adjacent each other and together forming a larger circular magnetic disc.

6. The device as claimed in claim 5, wherein the secondary magnet is in the form of a disc with a first end resembling a first layer defining the north pole and the a second end forming a second layer defining the south pole, and with either the north pole or the south pole of the secondary magnet facing the two primary magnets.

7. The device as claimed in claim 1, comprising a holder for securing the at least one primary magnet to the rotatable shaft.

8. The device as claimed in claim 1, comprising a dampening means arranged between the at least one primary magnet and the secondary magnet for absorbing noise or shock when the electric motor is in operation.

9. The device as claimed in claim 8, wherein the dampening means is in the form of a sponge pad or a Teflon pad.

10. The device as claimed in claim 1, wherein the modified motion output means includes or takes the form of a holder from which a modified motion output shaft extends or to which the modified motion output shaft connects, and configured to abut the secondary magnet whereby motion from the secondary magnet is translated to the modified motion output shaft.

11. The device as claimed in claim 10, comprising a means for securing the secondary magnet in the device, wherein a clearance is provided between the secondary magnet and surrounding structure of the secondary magnet, whereby in operation the secondary magnet is movable within the clearance and the modified motion output shaft is caused to deliver the modified output motion.

12. The device as claimed in claim 11, comprising an O-ring in the clearance surrounding the secondary magnet.

13. The device as claimed in claim 10, comprising a housing having a first housing member primarily for accommodating the motor and a second housing member for securing the secondary magnet in place and for connection with the first housing member, wherein the modified motion output shaft extends via an opening of the second housing member.

14. A method of constructing a device for generating a combination of rotational motion and oscillation motion in a third motion output means, comprising:
providing a first motion means in the form of a rotatable motion output shaft driven by a motor, the first motion means adapted to rotate at a rotation axis;
providing a primary magnet connected to the first motion means and adapted to rotate with a first motion output means, the primary magnet configured with two ends resembling two semi-circular discs, one in north pole and the other in south pole;
providing a secondary magnet positioned adjacent the primary magnet, the secondary magnet configured with two layers resembling two circular discs, one in north pole and the other in south pole;
positioning the secondary magnet such that either the north pole or the south pole of the secondary magnet faces the primary magnet;
providing a motion means in the form of an output seat member and abutting the secondary magnet such that movement of the secondary magnet is translated to a second motion means; and
securing the second motion means in the device and allowing a clearance surrounding the secondary magnet such that, in operation, rotation of the first motion means translates to a combination of rotational motion and oscillation motion in a third motion output device in the form of an output shaft extended from the second motion means.

15. (canceled)

16. (canceled)

17. (canceled)

18. A device for converting a rotating input motion into a modified output motion comprising:
a magnetic coupler including a secondary magnet, a motion output member, and at least a first primary magnet;
wherein a magnetic or polarity profile of the first primary magnet and a magnetic or polarity profile of the secondary magnet are different; and
wherein the device is configured such that rotating movement of the primary magnet translates to a combination of rotating and oscillating movement of the motion output member.

19. (canceled)

20. (canceled)

21. The device of claim 1, further comprising:
an electric tool assembly for receiving the device.

22. The device of claim 21, wherein the electric tool assembly is an electric brush.

23. The device of claim 21, wherein the electric tool assembly is an electric toothbrush.

24. The device of claim 18, further comprising:
an electric tool assembly, wherein the electric tool assembly receives the device.

25. The device of claim 24, wherein the electric tool assembly is an electric brush.
